(19) United States
(12) Patent Application Publication
(10) Pub. No.: US 2006/0239691 A1
(43) Pub. Date: Oct. 26, 2006

(54) Optical transceiver with connector

(75) Inventor: William A. Pender, Hollywood, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Operations, Inc., Naperville, IL (US)

(21) Appl. No.: 11/110,978

(22) Filed: Apr. 20, 2005

(51) Int. Cl. H04B 10/00

(52) U.S. Cl. 398/139

(57) ABSTRACT

An optical transceiver includes a housing with an optical connector in mechanical contact therewith. The optical connector at the optical transceiver allows for an optical connector at an end of a fiber optic drop cable to be connected directly to the optical transceiver. This transceiver housing/optical connector arrangement replaces labor and material intensive “pigtail” designs in which a “pigtail” fiber optic cable stemming from the optical transceiver connects to one side of a dual connector in an Optical Network Terminal (ONT) and a fiber optic cable from an Optical Line Terminal (OLT) connects to the other side of the dual connector. Thus, optical connections and associated materials and labor are reduced in an optical network terminal.

### BACKGROUND OF THE INVENTION

In recent years, there have been a concerted efforts by communications networks service providers to improve speeds of the “last mile” in communications networks. The “last mile” generally refers to the link from a Central Office (CO) of a communications network to a subscriber site, such as a personal residence or business facility. Improvements are being made to increase the speed by replacing wired telephony lines, which support limited bandwidth, with broadband communications cables or even fiber optic communications cables.

Communications Network Terminals (NT's) are typically found at each subscriber site and may include one or more technologies for converting high data rate signals to lower data rate signals that subscriber equipment, such as Personal Computers (PC's), can use for supporting communications. For example, the network terminals may include optical transceivers with optical-to-electrical converters that convert high-speed optical communications signals to electrical communications signals and vice versa to enable the subscriber equipment to communicate via optical networks.

### SUMMARY OF THE INVENTION

The principles of the present invention may be applied to an optical transceiver. The optical transceiver may include a housing that supports an optical transmitter and optical receiver. The optical transceiver may also include an optical connector in mechanical contact with the housing. The optical connector is adapted to mate with an optical connector associated with an optical fiber, which supports optical signal transmissions in a fiber optic drop cable between the optical transceiver's (i.e., proximal) transmitter and receiver and a distal optical transmitter and receiver located at a far end of the optical fiber.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a network diagram of an optical network in which an optical transceiver according to the principles of the present invention may be deployed;

FIG. 2 is a pictorial diagram of an Optical Network Terminal (ONT) in the optical network of FIG. 1 in which the inventive optical transceiver may be located;

FIG. 3A is a pictorial diagram of the ONT of FIG. 2 using a prior art embodiment of the optical transceiver used in office routers or long haul systems;

FIG. 3B is a pictorial diagram of another embodiment of the prior art embodiment of the transceiver and interfacing thereto used with a fiber optic drop cable;

FIG. 4A is a diagram of an embodiment of the optical transceiver according to the principles of the present invention used in the ONT of FIG. 2;

FIG. 4B is a diagram of the optical transceiver of FIG. 4A connected to a fiber optic drop cable; and

FIG. 5 is a schematic diagram of the optical transceiver of FIG. 4A as connected to a fiber optic drop cable in FIG. 4B.

### DETAILED DESCRIPTION OF THE INVENTION

A description of preferred embodiments of the invention follows.

The principles of the present invention provide cost reduction apparatus and method for connecting an optical fiber drop cable to an optical transceiver. In one embodiment, the optical transceiver includes a captive fiber mechanical receptacle (i.e., connector) that is adapted to connect with a connector at the end of an optical fiber. The cost reduction comes into play by obviating need for components that are presently used with each optical transceiver and labor and materials associated with their usage. Through use of an optical transceiver embodiment as disclosed herein, technicians installing optical fibers in, for example, the “last mile” using a fiber optic drop cable of a communications network save time and reduce potentially damaging processes associated with cleaning fiber ends.

The term fiber optic “drop” cable used herein indicates a fiber optic cable that is used in a fiber optic communications application having relatively high power optical transmissions, carried by fiber optic cables, that are highly sensitive to alignment errors in optical connectors that are used to link optical fibers together or to transmitter/receiver components. An example in which a drop cable is used is a home or office fiber optic drop cable link between a Central Office (CO) Optical Link Terminal (OLT) and home or office Optical Network Terminal (ONT) providing optical-to-electrical conversion for converting optical signals to Radio Frequency (RF) electrical signals for use by, for example, cable televisions, which is the reason for the high power optical signals. Examples of “enterprise” applications in which fiber optic cable communications carry low optical power signals carrying digital data and are thus less sensistive to connector alignment errors are office routers and long haul systems, where the term fiber optic “drop” cable as used herein does not generally apply to these low power applications.

For example, in current Broadband Passive Optical Network (BPON) Optical Network Terminal (ONT) technology with video overlay, prior art optical transceivers in the ONT have a fiber pigtail to ensure optical alignment between the fiber optic cable and optical devices in the optical transceivers. The pigtail ends with an SC optical connector. This connector is put into an optical adapter, which is typically a dual female connector, to connect the pigtail to another special captive SC optical connector on the end of a fiber optic cable.

Through use of an optical transceiver according to the principles of the present invention, the fiber optic drop cable can be connected directly to the optical transceiver, which removes (i) the optical adapter and (ii) a need for a “pigtail” on the optical transceiver. The captive receptacle on the optical transceiver facilitates a rugged fiber optic cable and connector assembly. The rugged assembly reduces a cost of the optical transceiver in an ONT because the traditional pigtail fiber and connector is no longer necessary. Also, manual operations for integrating a pigtail are no longer necessary to be done by the manufacturer. Furthermore, the captive receptacle solution renders a need to clean the fiber pigtail at the factory and in the field unnecessary, thus reducing operating costs.

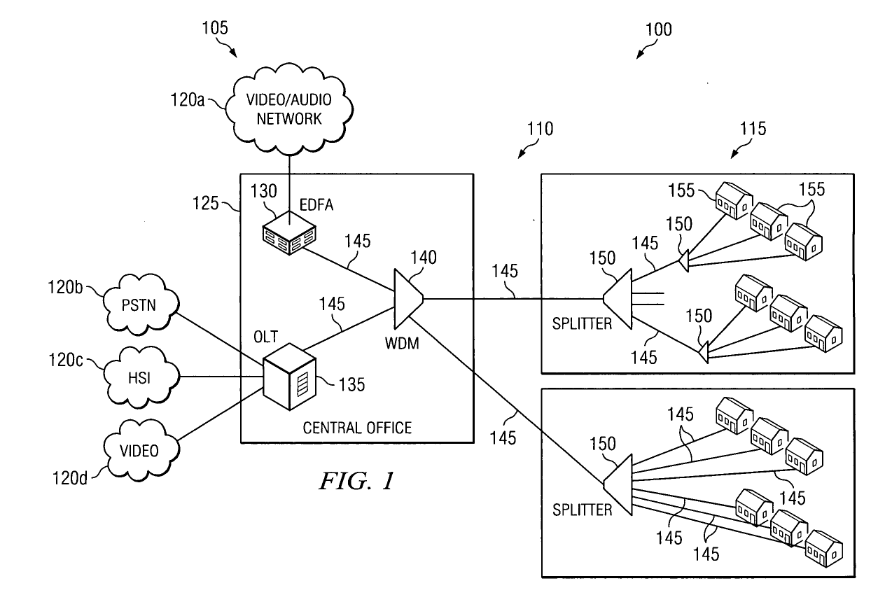

FIG. 1 is a network diagram of an example communications network 100 in which an optical transceiver according to the principles of the present invention as described above may be employed. The communications network 100 includes a server subnetwork 105 and a client subnetwork 115 connected via network communications paths 110. The server subnetwork 105 may be a Broadband Passive Optical Network (BPON) that has multiple other networks, such as a video/audio network 120a, Public Switched Telephone Network (PSTN) 120b, High Speed Internet (HSI) network 120c, and video network 120d. Also in the server subnetwork 105 is a Central Office (CO) 125 through which optical signals are communicated via optical communications networking equipment, such as an Erbium Doped Fiber Amplifier (EDFA) 130, an Optical Line Terminal (OLT) 135, and Wavelength Division Multiplexer (WDM) 140. Each of these components 130, 135, and 140 are connected via fiber optic cables 145.

The output of the WDM 140 is connected to splitters 150 in the client subnetwork 115 of the network 100 via the fiber optic cables 145. The splitters 150 separate optical communications into subchannel communications for delivery to and receipt from subscriber sites 155, such as residences and business facilities. Optical communications may use Wavelength Division Multiplexing (WDM), Time Division Multiplexing (TDM), or other communications protocol(s) supporting multiple subscribers or network access points.

Continuing to refer to FIG. 1, the video/audio network 120a is connected to the CO 125 at the EDFA 130, which receives and amplifies optical signals for further transmitting in the fiber optic cables 145. The other networks 120b through 120d are connected to the CO 125 via the OLT 135, which may also include EDFA's 130 for receiving and amplifying optical signals for further transmissions. It should be understood that the OLT 135 may include EDFA's 130, receivers, and transmitters for communicating optical signals in both directions.

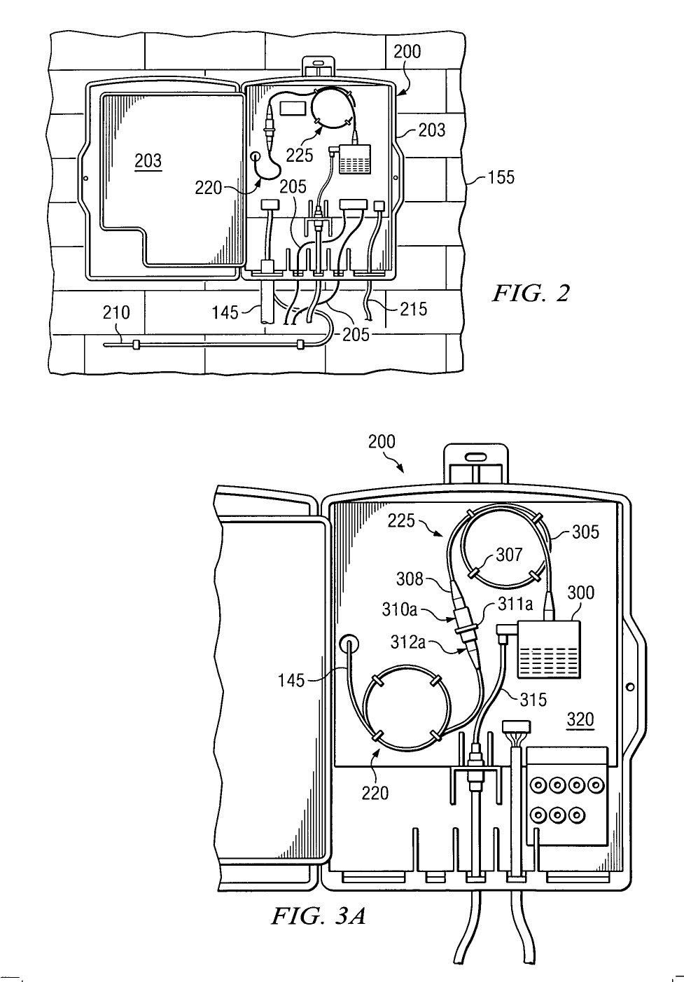

Each OLT 135 in the CO 125, which may contain more than one OLT 135, connects to up to thirty-two Optical Network Terminals (ONT), not shown here but shown in detail in FIG. 2, which are located at each subscriber site via a network of fiber optic cables 145 and optical splitters 150, as shown in FIG. 1. The ONT includes at least one optical transceiver (not shown here, but shown in FIGS. 2-5).

FIG. 2 is a pictorial diagram of an Optical Network Terminal (ONT) 200 into which multiple cables are installed and terminated, including the fiber optic cable 145 from the OLT 135, telephone wires 205, coaxial cable 210 for CATV, and Ethernet cables 210. The fiber optic cable 145 may be an indoor-type fiber optic cable 145 that can be seen as a small loop 220 that attaches to an optical connector in the upper left of the ONT 200 and again from the optical connector in pigtail form as a round circle 225 on the upper right of the ONT 200. For simplicity, outdoor and indoor forms of fiber optic cables 145 are both referenced as fiber optic cables 145.

An ONT is placed at each subscriber site (i.e., home or office) 155. It may be placed indoors, such as in a utility closet, or it may be mounted on the side of the subscriber site 155 where it may be mounted inside a secure, weather-proof housing 203, sometimes referred to as a Network Interface Device (NID) enclosure 203.

The actual optical fiber in the fiber optic cable 145 is extremely small in diameter, about the diameter of a human hair, and is very fragile. For ease of use and protection, the optical fiber is wrapped in multiple layers of protective material whose diameter varies depending on the intended usage. For use in the outdoors, the fiber optic cable 145 is several inches in diameter. As it nears its intended destination, layers of material are removed to make it smaller and easier with which to work.

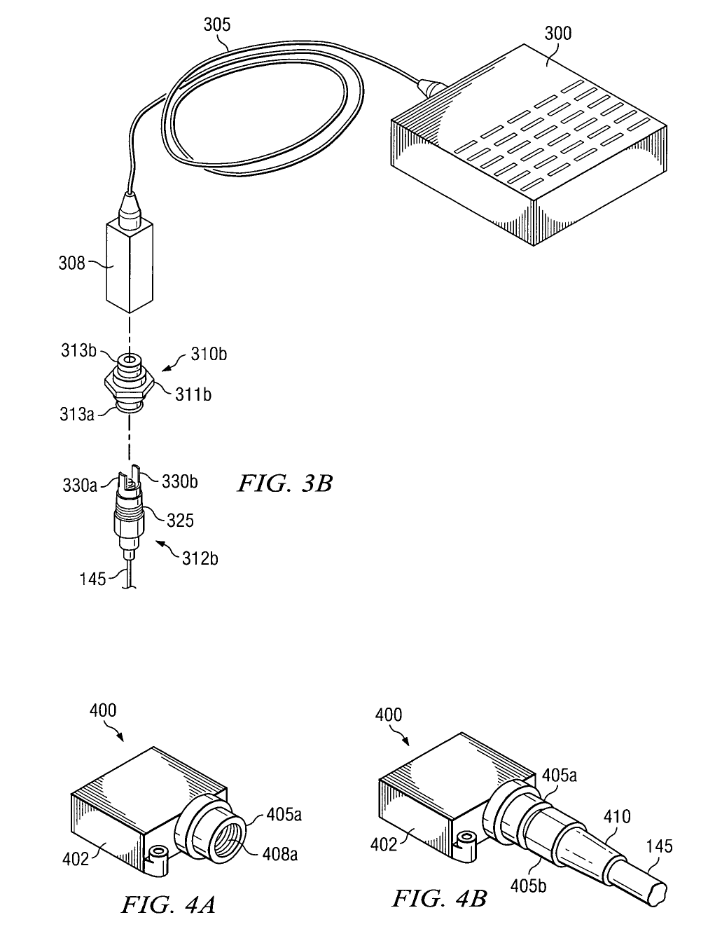

As indicated in FIG. 2 and in a close-up view in FIGS. 3A and 3B, the fiber optic cable 145 from the OLT 135 enters the NID enclosure 203 on its bottom side and is terminated in a male connector 312 that plugs into a double-sided female connector 310 held in place by a mounting plate 311 that is secured in the ONT 200. This mounting plate 311 increases material costs and manufacturing time because it is placed and installed by hand.

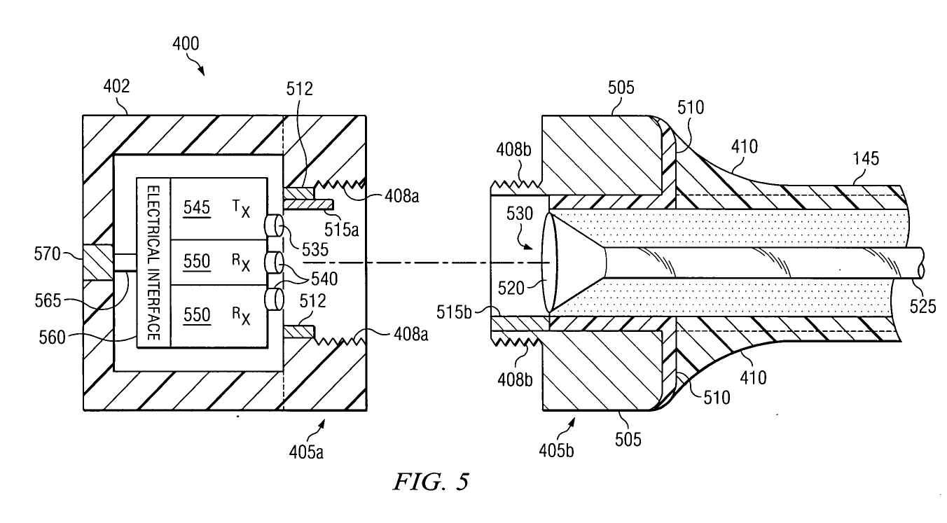

FIG. 3A shows in more detail the interconnections between (i) the fiber optic cable 145 and double-sided female connector 310a and (ii) double-sided female connector 310a and pigtail cable 305 that stems from an optical transceiver 300. The optical transceiver 300 is interchangeably referred to herein as a “triplexer” 300 because in some embodiments, the transceiver includes three optical elements: one transmitter and two receivers (shown in FIG. 5). Note that in FIG. 3A, the fiber optic cable 145 is an indoor type of cable, not the protected outdoor type of fiber optic cable 145 that is normally used in a subscriber site 155. The pigtail 305 from the triplexer 300 on the ONT PC board 320 is plugged into the other side of the double-sided, female, optical connector 310a. An electrical cable 315 is used to carry electrical signals corresponding to optical signals on the fiber optic cable 145 to network devices (not shown) that a user uses to communicate with network devices on the network side of the OLT 135. The electrical cable 315 may include provisions for providing power to the transceiver 300.

The fiber 145 from the OLT 135 is generally much larger due to its protective covering and terminates in an optical connector 312a, which is connected to a heavy duty, double-sided, female connector 310a held in the mounting plate 311a. The prior art embodiment of FIG. 3A illustrates how the very thin fiber optic pigtail 305 from the double-sided female connector 310a is routed and connected to the triplexer 300 that is mounted in the ONT's PC board 320. In this preferred embodiment, the pigtail 305 is coiled and held to the PC board 320 with small clips 307. This placement is a costly, time consuming, inefficient operation performed by hand during manufacturing. Adding the pigtail 305 and connector 308 to the triplexer 300 during its manufacture increases its costs and reduces its reliability because this, too, is a manual operation.

The triplexer 300 terminates the optical signals from the OLT 135 and converts them to electrical signals. The triplexer 300 also converts electrical signals from the ONT 200 into corresponding optical signals and sends the optical signals towards the OLT 135 across the fiber optic cable 145. The triplexer 300 is one of the most costly components in the ONT 200.

The prior art topology described above requires two male connectors 308 and 312a, one double-sided female connector 310a, a mounting plate 311a, and a pigtail 305 to connect the fiber 145 from the OLT 135 to the triplexer 300 in the ONT 200. This arrangement includes extensive material, manual operations, and costs. Reliability is reduced because there are multiple places where components can be broken, misaligned, or improperly cleaned.

FIG. 3B is a second prior art topology that is used in the ONT 200. The fiber optic cable 145 from the OLT 135 has a connector 312b attached to its end. The connector 312b includes features that are particularly suited for optical interfacing the ends of the fiber optic cable 145 and the fiber optic pigtail cable 305. For example, the connector 312b includes screw-type threads 325 and alignment/polarization keys 330a and 330b to ensure that the connector 312b is properly aligned and oriented with a mating connector 310b. The mating connector 310b is adapted to receive (i) the fiber optic cable 312b in one of its female connectors 313a and (ii) the connector 308 attached to the pigtail 305 from the transceiver 300 in the other female connector 313b. Similar to the connector 310a of FIG. 3A, the connector 310b is a double-sided female connector 310b with a mounting plate 311b adapted to support the connector 310b in association with the PC board 320.

The distinction between FIG. 3A and FIG. 3B is that the connectors 310b and 312b of FIG. 3B are more mechanically reliable, larger, and suitable for outdoor applications than the connectors 310a and 312a of FIG. 3A. Therefore, the embodiment of FIG. 3B may be used in ONT's 200 that are found connected to homes or other end user applications at the end of, for example, the “last mile,” where more optical power is carried by the fiber optic cable 145, for example, for cable television service. In this circumstance, better optical alignment than required for the enterprise applications is required to ensure good signal strength from the fiber optic cable 145 to the transceiver 300. The fiber optic cable 145 at the ONT 200 is sometimes referred to as a “drop cable” because of its proximity to an end user node. The connector 312b and associated adapter connector 310b are designed to provide the alignment and orientation necessary for the pigtail connector 308 to mate with the fiber optic cable 145 sufficiently to support a high optical signal transfer between the fiber optic cable 145 and pigtail 305. The pigtail 305 assembly ensures a good connection between optical elements (not shown) in the transceiver 300 that physically couple to the pigtail 305 to maximize optical coupling.

In the embodiment of FIG. 3B, the high quality fiber optic cable connectors 312b and 310b ensure good optical alignment between ends of the fiber optic cable 145 and pigtail 305. However, in both embodiments of FIGS. 3A and 3B, the pigtail 305 is employed, which, as described above, necessarily results in added materials expense, maintenance expense, and potential for damage to the ends of the optical fiber 145.

The principles of the present invention reduce costs and labor associated with the “pigtail” configuration by eliminating the double-sided female connector 310a or 310b and its mounting plate 311a or 311b, respectively, the pigtail 305 and its male connector 308, and multiple manual alignment, cleaning, and installation operations.

FIG. 4A is a diagram of an embodiment of the transceiver 400 having an associated connector 405a according to the principles of the present invention. The transceiver 400 includes a housing 402, supporting an optical transmitter and receiver (not shown), and the connector 405a. By having the connector 405a associated with the housing 402 of the transceiver 400, the male connector 312 on the fiber optic cable 145 from the OLT 135 plugs directly into the female connector 405a on the transceiver 400. The result is mechanically simple, less prone to failures (since there are fewer components in connections that have to be made), efficient (no manual operations to secure the pigtail, to mount the connector, to hold it, etc.), and costs less than the prior art pigtail configuration.

FIG. 4B is an illustration of the transceiver 400 with its housing 402 and associated connector 405a. The fiber optic drop cable 145 and its connector 405b are shown in a mated configuration with the connector 405a of the transceiver 400. An example of the connector 405a and its mating connector 405b is an Optifit® connector made by Corning Cable Systems.

There are several embodiments in which the housing 402 and connector 405a can be associated. For example, the housing 402 and connector 405a may be integrated during manufacturing of the housing 402, such as cast as a single unit. In another embodiment, the connector 405a can be attached, affixed, secured, inserted, press fit, adhered, or otherwise connected to the housing 402 after the housing is formed. It should be understood that any form of mechanical connection between the housing 402 and connector 405a can be employed during manufacturing or assembly processes of the transceiver 400.

The connector 405a preferably includes a form of strain relief. For example, in FIG. 4A, a screw-type thread 408a can be seen inside the connector 405a. This thread 408a, in combination with a mating screw-type thread (not shown) on the connector 405b, serves as a strain relief and protects the optical end of the fiber optic drop cable 145. Other forms of strain relief, such as clasps, screws, latches, detents, or other mechanical embodiments, may be employed to serve as strain relief to protect the connector 405b from dislodging from the connector 405a on the housing 402. The strain relief provided by the threads 408 may also serve to provide optical alignment between optical signals transmitting across an air path defined between the optical transceiver connector 405a and the fiber optic cable connector 405b. A different strain relief 410 between the connector 405b and fiber optic cable 145 may be employed to maintain connection between the connector 405b and fiber optic cable 145. This additional strain relief 410 also allows for a certain amount of bending and stiffness at the connector 405b, as known in the art.

FIG. 5 is a mechanical diagram of the transceiver 400. The housing 402 is shown by way of cross section. The housing 402 supports a transmitter 545 and two receivers 550 in this triplexer 400 embodiment. Other numbers and arrangements of transmitters 545 and receivers 550 may be used in other embodiments. Also in this embodiment, an electrical interface 560 is connected to the transmitter 545 and receivers 550. The electrical interface may be electrically connected to an electrical connector 570 via an electrical bus 565, which may be connector pins, short cable, or other electrically conductive pathway(s).

The transmitter 545 is connected to an electro-optic device 535, such as a laser diode, and the receivers 550 are electrically connected to optoelectronic devices 540, which may be silicon-based devices or other devices used to receive optical signals and convert them into electrical signals, as well known in the art. The electro-optic device 535 and optoelectronic devices 540 may be mechanically arranged in various ways relative to the connector 405a to enable optical coupling with an optical fiber 525 in the fiber optic cable 145.

The male connector 405b is illustrated at an end of the fiber optic cable 145. Inside the fiber optic cable is the fiber optic 525 through which optical transmissions travel. At the end of the fiber optic 525, in some embodiments, the fiber optic 525 expands in a bell shape 530 and connects to a small lens assembly 520 to enable optical signals to be transmitted into and out of the optical fiber 525 with maximum optical insertion/extraction. In other embodiments, other optical insertion/extraction techniques are employed. It should be understood that the optical coupling techniques employed are relatively unimportant for an understanding of the principles of the present invention, although choice of connector 405a, 405b must be suitable for optical interfacing between optical devices 535, 540 and optical fiber assemblies 520, 535, 530 or the like. Note that the optical insertion/extraction techniques disclosed herein are simplistic and are in no way intended to limit the scope of the present invention.

Through this configuration, the transmitters 545 and receivers 550 supported by the housing 400, which may be referred to as proximal transmitters and receivers, communicate with distal transmitters and receivers (not shown), such as at the OLT 135, via optical signal transmissions supported by the optical fiber 525.

As described above, the housing 400 is associated with the connector 405a. In the embodiment of FIG. 5, the connector 405a is a female connector adapted to receive a male connector 405b. The connector 405a includes threads 408a to receive opposing threads 408b on the male connector 405b. The female connector 405b may also include a rotating ring 505 that is mechanically separated from the rest of the male connector 405b via a gap 510 or a mechanism to allow the threads 408b of the male connector 405b to rotate relative to the threads 408a of the female connector 405a.

The connector 405a may also include stops 512, which may serve as hermetic seals when the male connector 405b is fully engaged with the female connector 405a. The female connector 405a and male connector 405b may include polarization keys 515a and 515b, which ensure that the connectors 405a and 405b are mated with a particular polarity to ensure optical signals transmitted via the optical fiber 525 are communicated with correct polarity or orientation between transmitters and receivers.

It should be understood that, although illustrated as a female connector 405a on the transceiver 400, another embodiment may use a male connector 405a associated with the transceiver 400, in which case, the connector 405b on the fiber optic cable 145 is a female connector 405b. However, because most systems existing in the field use male connectors at the ONT-end of the fiber optic cables 145, a female connector 405a associated with the transceiver 400 is preferable to support legacy installations. Also, the connector 405a may be designed to mate with the connector 312 used in existing installations and provide sufficient strain relieving. Alternatively, the connectors 405a and 405b may be selected for new ONT deployments without concern for legacy installations.

The transceiver 400, connectors 405a and 405b, fiber optic cable 145, and other associated components are sometimes referred to as a “drop cable assembly.” A technician or other personnel may assemble a drop cable assembly by inserting the cable connector 405b into the transceiver connector 405a in a manner described above. It should be understood that a transceiver manufacturer or transceiver housing manufacturer can manufacture the transceiver housing 402 with transceiver connector 405a in any manner known in the art, including through custom techniques.

While this invention has been particularly shown and described with references to preferred embodiments thereof, it will be understood by those skilled in the art that various changes in form and details may be made therein without departing from the scope of the invention encompassed by the appended claims.

For example, although the principles of the present invention are described in reference to an optical transceiver, they equally apply to other optical devices in which a pigtail or other fiber optic cable and adapter connector arrangement to the optical device can directly be replaced with a simpler connector arrangement as described herein. Similarly, the principles of the present invention may be equally applied to electrical, acoustical, microwave, or other electromagnetic wave devices.

The optical transceivers employing the principles of the present invention are described herein as being applied for use at the subscriber sites 155; however, it should be understood that optical transceivers may be used wherever advantages as described herein may be leveraged.

What is claimed is:

1. An optical transceiver, comprising:
a housing supporting at least one proximal optical transmitter and proximal optical receiver; and
a first optical connector in mechanical contact with the housing and adapted to mate with a second connector associated with an optical fiber supporting optical transmissions in a fiber optic drop cable between the at least one proximal optical transmitter and receiver and at least one distal optical transmitter and receiver.

2. The optical transceiver according to claim 1 wherein the first optical connector is integral with the housing.

3. The optical transceiver according to claim 1 wherein the first optical connector is coupled to the housing.

4. The optical transceiver according to claim 1 wherein the first and second optical connectors include respective alignment keys.

5. The optical transceiver according to claim 1 wherein the first optical connector includes at least one precision mating structure adapted to interface with a complementary at least one precision mating structure on the second optical connector.

6. The optical transceiver according to claim 5 wherein the at least one precision mating structure is a screw-type thread.

7. The optical transceiver according to claim 1 wherein the first optical connector is a female optical connector and the second optical connector is a male optical connector.

8. The optical transceiver according to claim 1 wherein the first optical connector is a male optical connector and the second optical connector is a female optical connector.

9. The optical transceiver according to claim 1 further including an electrical connector associated with the housing via which electrical signals corresponding to optical signals to or from the at least one proximal transmitter or receiver respectively, are electrically conducted.

10. The optical transceiver according to claim 1 wherein the optical transmissions include optical signals convertable to Radio Frequency (RF) electrical signals.

11. The optical transceiver according to claim 1 used in an optical network terminal.

12. A method of manufacturing an optical transceiver, comprising:
forming a housing adapted to support at least one proximal optical transmitter and proximal optical receiver; and
associating a first optical connector in mechanical contact with the housing adapted to mate with a second optical connector associated with an optical fiber supporting optical transmissions in a fiber optic drop cable between the at least one proximal optical transmitter and receiver and at least one distal optical transmitter and receiver.

13. The method according to claim 12 wherein associating the first optical connector with the housing includes forming the optical connector in a manner integral with forming the housing.

14. The method according to claim 12 wherein associating the first optical connector with the housing includes coupling the first optical connector with the housing after forming the housing.

15. The method according to claim 12 further including defining an alignment key in the first optical connector to ensure alignment between the first and second optical connectors in a mated configuration.

16. The method according to claim 12 wherein the first optical connector includes at least one other precision mating structure adapted to interface with a complementary at least one precision mating structure on the second optical connector.

17. The method according to claim 16 wherein the at least one precision mating structure is a screw-type thread.

18. The method according to claim 12 wherein the first optical connector is a female optical connector and the second optical connector is a male optical connector.

19. The method according to claim 12 wherein the first optical connector is a male optical connector and the second optical connector is a female optical connector.

20. The method according to claim 12 further including mechanically associating an electrical connector with the housing via which electrical signals corresponding to optical signals to or from the at least one proximal transmitter or receiver, respectively, are electrically conducted.

21. The method according to claim 12 wherein the optical transmissions include optical signals for convertable to Radio Frequency (RF) electrical signals.

22. The method according to claim 12 performed in connection with an optical network terminal.
